(19) United States
(12) Patent Application Publication
(10) Pub. No.: US 2002/0123949 A1
(43) Pub. Date: Sep. 5, 2002

(54) System and method for financial management and analysis

(76) Inventor: Michael J. VanLeeuwen, Salt Lake City, UT (US)

Correspondence Address: Attn: Steve M. Perry, THORPE NORTH & WESTERN L.L.P., P.O. Box 1219, SANDY, UT, 84091-1219, US

(21) Appl. No.: 10/024,128

(22) Filed: Dec. 17, 2001

Related U.S. Application Data
(60) Provisional application No. 60/256,244, filed on Dec. 15, 2000.

(51) Int. Cl. G06F 17/60

(52) U.S. Cl. 705/35

(57) ABSTRACT

A method is provided for analyzing a user's finances and providing a plan for debt reduction. The method includes acquiring aggregated financial data for a user from a financial data clearinghouse. Another step is classifying financial transactions received with the aggregated financial data into a plurality of budget categories without user input. A further step is applying the financial transactions to the budget categories. The budget categories further include a budget amount and budget balance. An additional step is modifying the budget balances without user input based on increases or decreases caused by the financial transactions. A further step is displaying the budget categories, budget amounts, modified budget balances and the financial transactions to aid the user in debt reduction.

This application claims priority from U.S. Provisional Patent Application No. 60/256,244 filed on Dec. 15, 2000.

### FIELD OF THE INVENTION

The present invention relates generally to financial management. More particularly, the present invention relates to an automated method and system for debt reduction and financial planning.

### BACKGROUND

Computer software has been widely used for financial tracking and financial data collection by individuals as well as for large organizations. Recently, in the personal computer world, many applications have emerged to aid individuals and their families in assessing their financial data and organizing personal finances. Examples of such applications are Microsoft's Money and Intuit's Quicken. There are many other software financial tools that exist in the personal computer market.

These financial analysis tools allow users to record data about their financial situation in a ledger entry type of system. Specifically, these applications allow users to collect information about specific accounts they own and the individual transactions posted to those accounts. These accounts may include savings accounts, checking accounts, investment accounts, credit card accounts, mortgage loans or other financial accounts.

Personal financial organization software can perform limited analyses based on simple financial formulas that can explain when a debt will be paid off or the amount of money spent in certain categories. For example, a user can track the length of time required to pay a mortgage down to zero based on the current payments and any extra principal payments the user is making. Other financial data can be displayed in simple reports and spreadsheets to allow the user to view income and expenditures. Users are able view reports that detail where their money was spent. Although useful information can be displayed, these applications essentially gather and display information entered by the user.

With these financial tools available in the public market, one would think that it would be easier to control a person's financial situation than ever before. Unfortunately, in recent years financial institutions have offered more debt and credit options to consumers than ever before. Most consumers receive offers for credit cards, credit for purchases of disposable goods, or purchases of automobiles on an “easy” payment plan. Even consumers with marginal or questionable credit records are offered the opportunity to accrue significant debt. Because of this ever-increasing opportunity to incur debt, many consumers find themselves in a position of being overloaded with debt.

Current financial tools allow a user to see a snapshot of their financial portfolio, but they do not allow that user to manage debt. Being able to see the income and expenditures for an individual's account does not necessarily mean that the individual will understand the principles related to debt and financial planning.

### SUMMARY OF THE INVENTION

A method is provided for analyzing a user's finances and providing a plan for debt reduction. The method includes acquiring aggregated financial data for a user from a financial data clearinghouse. Another step is classifying financial transactions received with the aggregated financial data into a plurality of budget categories without user input. A further step is applying the financial transactions to the budget categories. The budget categories include a budget amount and budget balance. An additional step is modifying the budget balances without user input based on increases or decreases caused by the financial transactions. A further step is displaying the budget categories, budget amounts, modified budget balances and the financial transactions to aid the user in debt reduction.

A more detailed embodiment of the invention is a method for guiding a user to reduce their debt. The method includes the step of acquiring an aggregation of financial data for a user from a financial data clearinghouse. The next step is classifying financial transactions received with the aggregated financial data into a plurality of budget categories without user input. Another step is applying the financial transactions to the budget categories, wherein the budget categories further include a budget amount. A further step is providing the user with a listing of expense reducing items that can reduce the user's debt. An additional step is comparing budget categories and the budget amounts to expense reducing items accepted by the user to define a budget margin for budget categories. A follow-up step is applying the budget margin to pay down the user's debts.

Another embodiment of the invention is a method for determining a financial debt that should be paid down first to reduce aggregate financial debt. The method includes the step of storing debt information for a plurality of financial debts. The debt information for each financial debt includes a principal amount, an interest rate, a periodic payment, and a debt payment length. Another step is selecting a debt which has a lowest remaining balance, a highest periodic payment, and a highest interest rate. A further step is communicating to a user that the selected debt should be paid off first to allow the plurality of debts to be paid off in a reduced amount of time.

In accordance with a more detailed embodiment of the present invention, a method is provided for determining a financial debt that should be paid down first to reduce a person's overall financial debt. This method includes the step of storing debt information for a plurality of debts. The debt information for each financial debt includes a principal amount, an interest rate, a periodic payment, and a debt payment length. Another step is comparing the periodic payment of each debt to the principal amount. A further step is creating a numerical ranking for each of the debts based on the comparison of the periodic payment to the principal amount. Yet another step is identifying the debt to pay off first, based on the highest numerical ranking of the debt to allow the plurality of debts to be paid off in a reduced amount of time.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram illustrating the organization of the debt reduction system;

FIG. 2 illustrates the bill management portion of the debt management system;

FIG. 3 illustrates the planned spending user interface to generate budgeting information;

FIG. 4 illustrates the organization of the wizards or planning methods used in an embodiment of debt management invention;

FIG. 5 is a block diagram illustrating financial factors to be considered in picking a debt to pay off first;

FIG. 6 is a block diagram illustrating one embodiment of a financial method for picking a debt to pay off first;

FIG. 7 illustrates the data flow in the system for preparing a debt management plan;

FIG. 8 is a block diagram illustrating the flow of data from a financial aggregation service into a budgeting and classification system;

FIG. 9 illustrates the processes that will be used for debt management.

### DETAILED DESCRIPTION

Reference will now be made to the exemplary embodiments illustrated in the drawings, and specific language will be used to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention includes a system and method for the compilation of financial information, electronic bill payment, debt reduction, retirement planning, and financial goal guidance. The debt reduction and future planning are driven by a number of automated planning tools that can assist a user in financial planning.

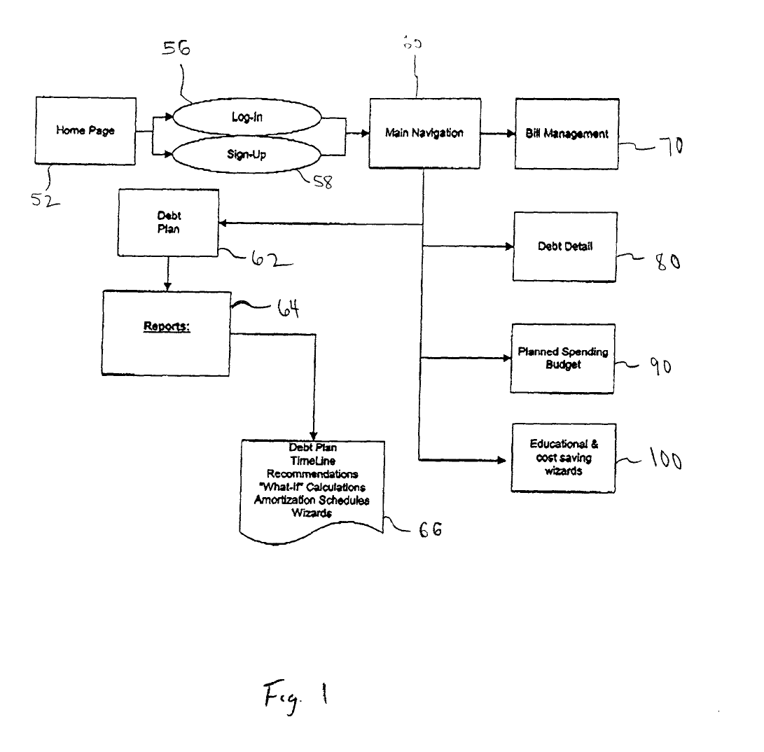

FIG. 1 is a block diagram illustrating an embodiment of the invention that includes the overall flow of the debt reduction and financial planning system. A user enters this system through a home page 52 if it is accessed as a web application or through another initial user interface screen. The user will then login 56 or be allowed to sign up onto the system 58. The user is then provided with a main navigation screen 60 to access the modules of the program. The specific modules are bill management 70, debt detail 80, planned spending budget 90, and the education and cost saving wizards 100. The data managed in each of these modules will be discussed in more detail later, but this information contributes to the creation of a debt plan 62 for the user. The creation of a debt plan for the user aids the user in reducing their debt and preparing for retirement. Reports can also be generated that summarize the detailed information in the system or how the user is progressing in their debt reduction plan 64. More specifically, a debt plan and its associated recommendations can be generated for the user along with a time line of that debt plan 66. In addition, “what-if” calculations can be produced and output in a report format. These what-if calculations allow the user to apply varying payment amounts and power payments to different debts to determine what the outcome would be. Amortization schedules can also be produced for the user to show how the debts will be paid down over time.

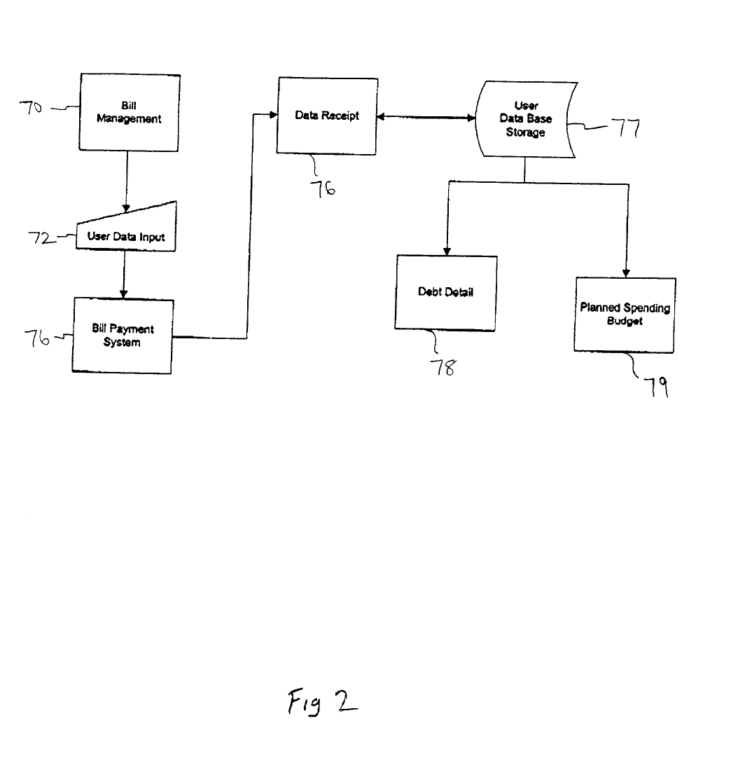

FIG. 2 illustrates the bill management portion of the debt management system. Bill management is an integral part of the system. The bill management module 70 allows the user to use a bill presentment and payment system or module 76. Once the user has entered the bill management module, the user is able to input personalized data 72. This data input by the user can include payment preferences, establishing bank account information, and setting up the bills to be paid.

The module for bill management can be setup for manual bill approval by the user or setup to forward all bills directly to a remote location for processing. Examples of an electronic bill presentment and payment system are Metavante or a proprietary bill payment module that is integrated with the present system. For example, when Metavante receives a user's bills, the information is scanned and returned to the debt management system 76. The bills are stored for processing by the system and viewing by the user 77. At the receipt of this information by the debt management system, a message is sent to the user informing them that billing information has been received and they can then authorize payment. The user can also view the debt information through the debt detail 78. The debt detail includes the bill payment information from the bill management system and other debts that are stored in the system (i.e., mortgage, vehicles, etc.). The user is also able to access the planned spending budget 79 from the bill management module, and this allows the user to compare the bills they have authorized to their planned spending budget.

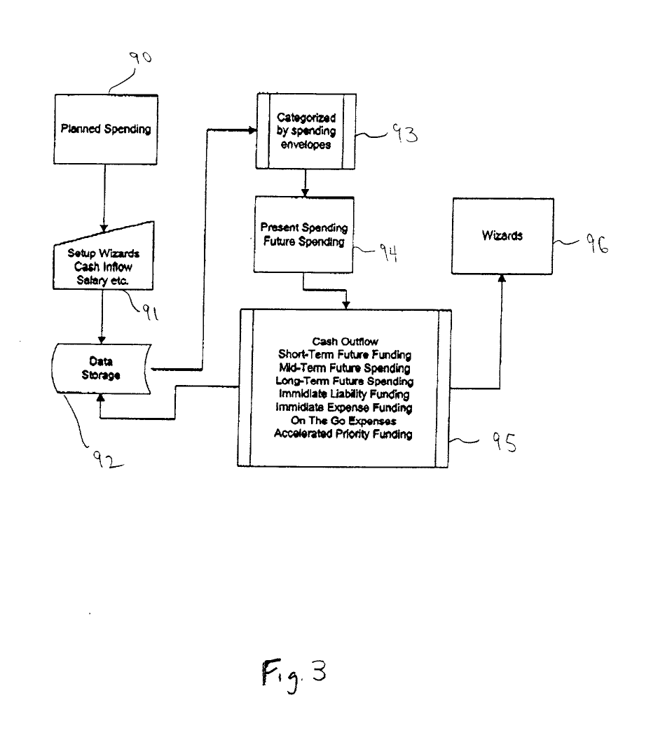

FIG. 3 illustrates a planned spending module 90 that organizes and tracks budgeting information. The planned spending module includes a user interview interface or setup wizard 91 where the system collects financial budgeting information from the user. The system records and analyzes cash inflows, cash outflows, investment, insurance information, etc. This budgeting information is collected and stored in a data storage component 92 or database. All the database information can be stored locally or on remote networked servers (e.g., through the Internet).

The data collected through an interview or guided wizard is categorized into budget categories 93. These budget categories are called envelopes because they contain a budget amount that is designated for a specific category. Some transactions will also be imported from other financial system and automatically categorized and applied to budget categories. This will be discussed in further detail later. Another portion of the planned spending module is the present spending and future spending analysis module 94. Users are presented information that allows them to see the amounts they are spending in each category and the amounts they have allocated.

In addition, planned spending helps users plan where they will spend their money and encourages users to anticipate future spending needs such as education, taxes, home improvements, etc. Users are encouraged to consider and plan for several categories of future spending 95. Users can view their cash outflow along with their immediate liabilities and expenses. After those needs are considered, the user can analyze the amounts being spent for “on-the-go” expenses such as lunch or spontaneously purchased snacks. The present method also helps the user plan their short-term, mid-term and long-term funding. Examples of these are investment information or insurance information to help the user prepare for retirement needs and understand objectives relating to retirement age and lifestyle. Once all these factors have been considered, then the user can decide what additional money remains to accelerate the funding of high priority future spending. High priority future spending might include the purchase of a furnace that is needed before winter starts, etc. The planned spending can display and analyze the information discussed above as wizards or guided questions 96.

The present and future spending categories will now be discussed in further detail. In these categories, a user defines monthly funding amounts or a cash inflow for each category. These categories provide a way to plan for future spending functions. For example, if a user has purchased a new automobile, then in 50,000 miles the tires must be replaced. Therefore, the user can have a category called auto future spending (a mid-term future spending fund) that allows the user to enter in the average mileage driven each month. The system then calculates how many months will pass before the tires must be replaced. Assuming it takes three years to drive 50,000 miles and the user who creates the category estimates the cost of tires to be $500, then the system can recommend funding the automobile future-spending category at $12 per month. The same type of event will happen for any future spending including property taxes, vacation, holiday needs, etc.

Each month a comparison is provided to show the progress the user is making and to provide the encouragement the user needs to continue on the debt reduction program. This might also include an incentive to help them save money. Partnerships with other providers or retail outlets can provide a service to notify them of an opportunity in their community. This may be movie tickets, grocery coupons, awards points for participation any number of things to keep them motivated.

These community partnerships can also be used to fund certain areas such as debt reduction or future saving plans. The partners can provide cash back on purchases a user makes and this cash back is applied to either debt reduction, retirement funding or another future fund specified by the user. This cash back and purchase can be automatically categorized and applied against a budget category.

Part of reducing debt is analyzing the cash outflows of a user and giving them positive feedback about that cash outflow. This empowers people to differentiate between needs, wants, and future plans. The cash outflow section also identifies specific spending categories. The first category can be “charitable donations.” This helps teach people the importance of selflessness and giving to others. Another category can be “basic living expenses.” This category can include the subcategory of shelter (home/rent) expenses, food (groceries), and clothing. The user will enter a planned budget amount into each category and subcategory.

Another category is titled “short-term future funding.” This category is generally defined as anticipated future funding needs that need to be met within the next 12 months. These expenses are those that come annually but usually only in certain months of the year. They include, but are not limited to the following items: property taxes, automobile insurance (RV's etc.), health insurance, maternity, optional medical procedures, life insurance, home repair/improvement, etc. This portion of the financial system allows the user to enter data in these areas for each of the twelve months of the year.

Yet another cash outflow category is “mid-term future funding.” This category is defined as anticipated future funding needs within a five-year period. These expenses are those that will occur in future years and might include the following items: a new automobile purchase, education for children, purchase of a new home, new tires for automobile, recreational property, recreational vehicles, dream vacation, etc. This category is flexible and enables the user to customize the list to the user's needs, wants, and view of the future in 5 years. The financial system can contain logic that prompts the user on additional items they may not consider as short-term funding needs.

“Long-term future funding” is another cash outflow category. This is generally defined as anticipated needs looking beyond five years. This category includes customization abilities to allow the user to identify those items that are anticipated beyond five years. This category can include items such as: college education, dream vacation, new home, retirement, a new furnace, a new water heater, new carpet, a new roof, etc. The user can select from a predetermined list of long term funding items or add items as required. They should also determine the year they plan to acquire the item/service, and the current item cost. The system stores the amount funded to date, the balance needed, months remaining to fund, and the monthly payment.

“Immediate liability funding” is a cash outflow category that includes debt payments, which are not housing. These are credit cards, student loans, automobile loans, etc. “Immediate expense funding” includes standard monthly expenses such as utilities, cable, etc. This section includes utilities, water, telephone, power, fuel, garbage, condominium fees, parking fees, newspaper subscriptions, Internet access, cable, etc. These expenses are monthly, ongoing expenses often with set amounts. “Incidental expenses” include gas expenses, lunch money, etc. This category is made up of spending items that are discretionary, and paid “on the go”. Users typically have pocket money that they spend on lunch, treats, quick trips to the grocery store, gas purchases, snacks, recreation, etc. All of these expenses need to be tracked and recorded to reflect an accurate cash flow of monthly expenditures.

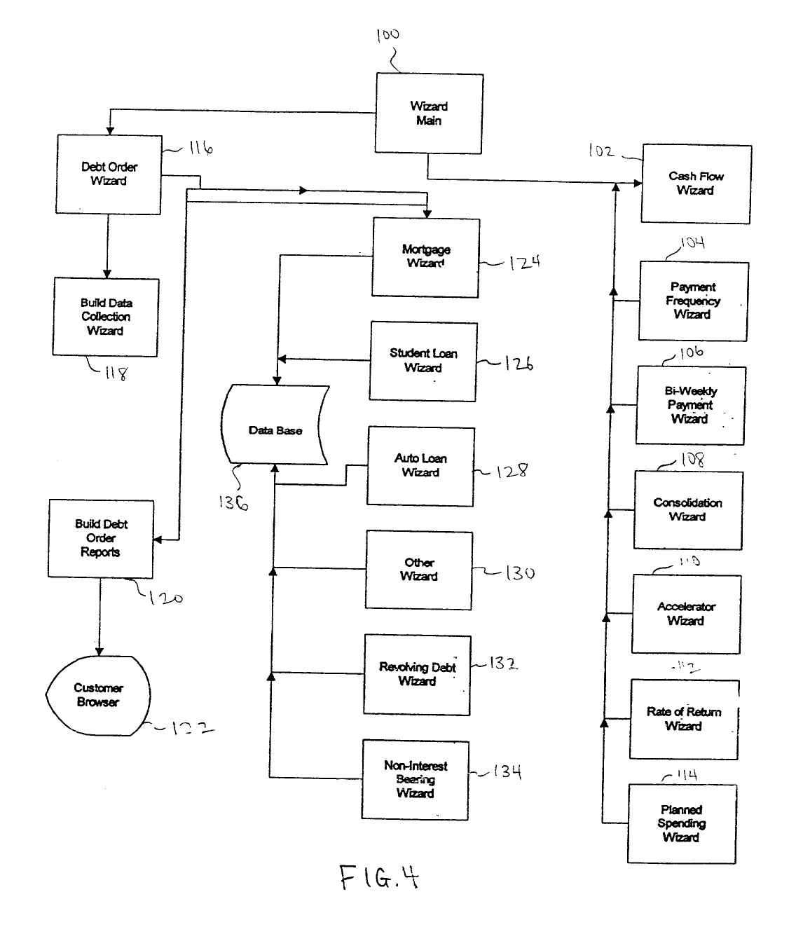

FIG. 4 illustrates the wizards 100 or guided financial analysis logic used in debt management. Wizards are the logic that take the collected data and prepare comparative data and potential options for the user to review. The wizard tracks when a milestone should be reached based on the debt reduction plan. The wizards follow and track the debt pay-down because of the regular information received about the payments made, and the new balances that are sent to the system when bills are paid. When a debt reaches zero balance, the application and wizards identify the debt as paid in full and removes the debt. Next, the system suggests the payment amount to be made to the next debt in the pay-off sequence.

Some of the wizards that are available to users are a cash flow 102, payment frequency 104, bi-weekly payment 106, consolidation 108, accelerator 110, rate of return 112 and the planned spending wizard 114. These analysis tools enable a user to determine how each of these financial areas can be used in their debt reduction and financial planning.

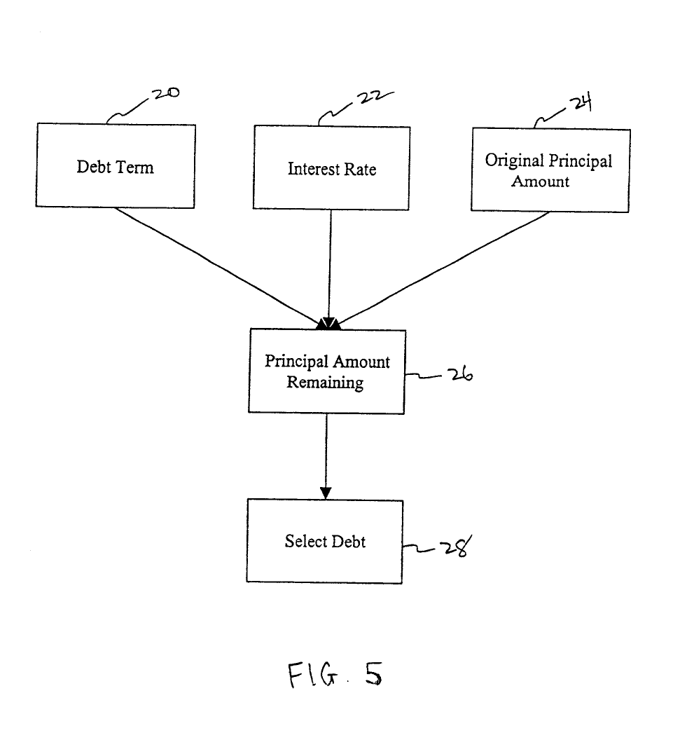

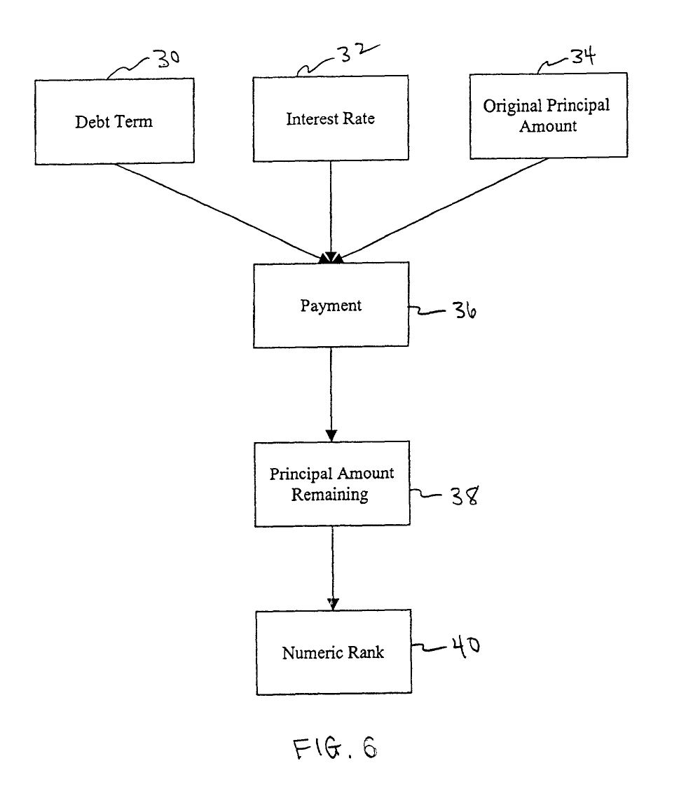

Another important analysis tool is the debt order wizard 116, which will be discussed in additional detail in FIGS. 5 and 6. The debt ordering module collects information about mortgages 124, student loans 126, auto loans 128, revolving debt (credit cards) 132, non-interest bearing loans 134, and any other debts 130. This collected information is stored in a database 136 where it can be accessed by the debt order wizard logic, which then produces a data collection table 118, or debt ordering calculation table. The user can access this debt ordering information through reports 120 viewed through a browser 122 or other interface.

One embodiment of this system and method includes guiding the user in debt reduction. In contrast to the prior art, this system uses an effective method to select the order in which debts should be paid off. As will be discussed in further detail later, the software presents screens that ask the customer for information concerning their debts. This debt information includes the original amount owed, current amount owed, interest rates, minimum monthly payments, start date of the loan, etc.

The system logic takes the debt information and determines a plan that minimizes the interest to be paid and the time to pay off the debts. In the prior art, the system for picking a debt to pay off first will select the debt with the highest interest rate. This seems to be a straightforward approach but it does not provide the maximum dollar benefit that the debtor needs. In other words, picking the debt with the highest interest rate does not necessarily pay off a debtor's debts in the least amount of time. Most prior systems simply apply the concept that the debt with the highest interest rate should be paid off first and once that debt is paid in full, the new surplus is applied to the payments for the debt with the next highest interest rate. This principle is often accurate when applied to long-term debt but it is not the best approach for short-term debt or a mix of long term and short-term debt. Instead, the time value of money must be taken into account when calculating the best plan for debt reduction.

Referring now to FIG. 5, the debt reduction logic considers the original principal amount 24, term length of the debt 20, and finally the interest rate 22 on the debt. These factors are combined and preferably measured against the baseline amount of principal owing 26 and allows the appropriate debt to be selected 28 and paid off first. The current principal amount can be used place of the original principal amount. Combining these factors provides a metric for measuring the time value of money when determining a sequence of payments. It also provides a plan to pay off all debts in a reduced amount of time and to minimize the interest paid. This analysis can also consider the option of consolidating debts, if possible, to enhance the objective of minimizing interest charges and time. After a consolidation or partial consolidation has taken place then this analysis is reapplied.

FIG. 6 illustrates another embodiment of the present invention. This method determines the order in which financial debt should be paid down to reduce a person's overall financial debt. This ordering is based on the debt as it is currently structured. As described, the user initially provides information about each of their multiple debts either by personally entering that information or having that information sent from their financial institution.

The information for each debt includes an original principal amount 34, a principal amount that is remaining 38, an interest rate 32, and a debt payment length 30. From this information about each loan, the periodic payment amount can be calculated 36. Alternately, the user can enter the amount of the minimum payment (e.g., just the interest). It is more helpful to have the system calculate the payment because in the case of a credit card the minimum payment extends the loan almost indefinitely.

Then the monthly payment or periodic payment of each debt is compared to the principal amount. This comparison considers the length of the term as compared to the other variables. A direct way to calculate this is to divide the payment amount by the remaining principal amount. As mentioned, the principal amount remaining can be used if necessary. A ratio is then produced which numerically ranks the debt based on the time value of money as compared to other debts. The debt with the highest ranking is paid off first. After that debt is paid off, then the payment for that debt is applied to the next highest-ranking debt. Since the logic can be applied at selected intervals or every time a debt is paid off, the debt rankings can change dynamically. Selecting the debt based on the highest numerical ranking allows all the debts to be paid off in a reduced amount of time as compared to prior methods.

The debts can be ranked in this manner. Suppose an individual has a $5,000 debt at 18% for 5 years with monthly payments. This would be ranked as a 0.027 when this method is applied. Another debt is $3,000 at 18% for 3 years with monthly payments. This second debt would receive a ranking of 0.037. Thus, the second debt should be paid off first. Based on conventional criteria it would appear that it does not matter which one is paid off first because they have the same interest rate. Further analysis using this method reveals that paying off the second debt first results in a savings.

A further example can now be shown. Suppose an individual has the following debts:

| | |
|---|---|
| Primary Mortgage | $150,000 at 8%, monthly P&I payment is $1,100.65 |
| 2nd Mortgage | $26,000 at 12.5%, adjustable rate mortgage, |
| | monthly pmt. $320.46 |
| VISA | $4,600 at 16.5% Minimum payment of $115.00 |
| MasterCard | $5,400 at 18% Minimum payment of $108.00 |
| Furniture Store | $3,200 at 18% Minimum payment of $96.00 |
| Student Loans | $7,800 at 9.5% Monthly payment of $100.93 |

In this example, the analysis will recommend that the user pay off the Furniture Store debt first because it is ranked the highest using the present system. It is ranked 0.03 and the other debts rank lower. This debt will be paid off in 47 months. After 47 months the balances for the remaining debts will be as follows:

| | |
|---|---|
| Primary Mortgage | $139,915.07 with 283 months remaining |
| 2nd Mortgage | $19,388.88 with 73 months remaining |
| VISA | $1,212.77 |
| MasterCard | $3,576.10 |
| Furniture Store | $0.00 |
| Student Loans | $5,579.70 with 73 months remaining |

A new evaluation can be made after each milestone is met to determine if other things have changed and if the consumer has added additional debts to their portfolio. The $96.00 per month that was being paid to the Furniture Store can now be applied to the VISA bill because this has the highest current ranking. This makes the total monthly payment to VISA now $211.00. In seven months, the VISA bill will be paid in full leaving balances on the remaining debts as follows:

| | |
|---|---|
| Primary Mortgage | $138,716.15 with 276 months remaining |
| 2nd Mortgage | $18,098.85 with 66 months remaining |
| VISA | $0.00 |
| MasterCard | $3,178.03 |
| Furniture Store | $0.00 |
| Student loans | $5,172.84 with 66 months remaining |

Now, the $211 per month payment that was being paid to the VISA bill should now be applied to the MasterCard bill making the total payment to MasterCard now equal to $319.00.

In 11 months the MasterCard bill, will be paid in full leaving balances on the remaining debts as follows:

| | |
|---|---|
| Primary Mortgage | $135,715.76 with 265 months remaining |
| 2nd Mortgage | $15,872.78 with 55 months remaining |
| VISA | $0.00 |
| MasterCard | $0.00 |
| Furniture Store | $0.00 |
| Student loans | $4,486.33 with 55 months remaining |

The $319.00 per month payment that was being paid to the MasterCard bill should now be applied to the Student Loans making the total payment to Student Loan equal to $419.93. In 12 months, the student loan will be paid in full leaving balances on the remaining debt as follows:

| | |
|---|---|
| Primary Mortgage | $141,533.92 |
| 2nd Mortgage | $13,136.70 |
| VISA | $0.00 |
| MasterCard | $0.00 |
| Furniture Store | $0.00 |
| Student Loans | $0.00 |

Now, the $419.93 per month payment that was being paid to the Student Loan should now be applied to the 2nd Mortgage making the total payment to the 2nd Mortgage equal to $740.39.

In 20 months, the 2nd Mortgage will be paid in full leaving balances on the remaining debts as follows:

| | |
|---|---|
| Primary Mortgage | $129,991.62 |
| 2nd Mortgage | $0.00 |
| VISA | $0.00 |
| MasterCard | $0.00 |
| Furniture Store | $0.00 |
| Student Loans | $0.00 |

The $740.39 per month payment that was being paid to 2nd Mortgage should now be applied to the Primary Mortgage making the total payment to Primary Mortgage equal to $1,841.04. In 96 months, the Primary Mortgage will be paid in fall leaving balances on the remaining debts as follows:

| | |
|---|---|
| Primary Mortgage | $0.00 |
| 2nd Mortgage | $0.00 |
| VISA | $0.00 |
| MasterCard | $0.00 |
| Furniture Store | $0.00 |
| Student Loans | $0.00 |

In 193 months or 16 years, all the debts are paid in full, including the primary real estate mortgage. This is in comparison to the user's original plan where the debts could take up to 30 years to pay off.

Some of the wizards listed are proactive. This means that the wizard will automatically remind, notify, and provide guidance to a user regarding which actions they should or should not be taking to help them reach their financial goals.

Now the data-gathering portion of the system will be discussed in further detail. In the present system, the user has the ability to enter in the data for each of their debts. A mortgage needs the start date of loan, the original principal amount, the interest rate (fixed, variable, balloon, negative amortization), and the term of the loan. From this information, the system can calculate the payment (P&I) for the user. Then an amortization table can be built that includes the interest for the period, the remaining balance, and the amount of principle applied each period, calculated over the entire term of the loan (30, 15, 10 yrs, etc.). This information can then be provided in a report format to indicate the total interest paid on this loan annually, or full term.

The user can also enter the expected principal and interest payment on the mortgage loan. This is separate from the taxes and insurance portion of the payment. Any other fees or escrow fees should be separated from the normal monthly payment. This aids in calculating the time left on the loan, if they have made additional principal payments on their loan. If the user has a fixed rate mortgage for a standard term, then the loan payoff can be evaluated in a standard manner. If the user has an adjustable rate mortgage or a balloon payment, or a negative amortization loan then there are additional considerations. The user then supplies the current interest rate, when the interest rate can be adjusted, what the adjustment can be, when the balloon payment will come due, the terms of the negative amortization, any adjustment rate, and any annual adjustment to the payment.

The present system can also track debts such as an equity line of credit. An equity credit line works like a revolving credit line for a period, generally 5-15 years. This means that the consumer is obligated to pay only a percentage of the outstanding balance. This is generally two to three percent of the principal balance. After that initial period, the debt will be paid off in the remaining balance of the term. For example, if the initial draw period is for 5 years and the term of the loan is 15 years, the loan must be repaid in 10 years. Therefore, the payment will need to change to reflect this payoff period. For this financial system to track this type of debt arrangement, it gathers the necessary information to make certain determinations and evaluations. The user can provide the amount of principal outstanding, the credit limit amount, the term of loan, both the payoff period and the draw period, the interest rate, and is it fixed or variable. If it is variable as will most often be the case, the user provides the adjustment periods and what the index is. The user can also provide a minimum payment as a percentage based on the outstanding balance.

Student loans typically have a unique set of payback options, which are different from most loans. Students are typically not required to pay back the student loans until 6 months after their graduation or non-enrollment in an institution. Information is gathered into the system database about when payments are expected to begin or when they began. Additional information required is the principal amount, annual interest rate, and the term of the loan.

Auto loans are straightforward. Information required for these loans includes principal amount, annual interest rate, and term. The system also gathers the start date of loan and first payment date. These loans typically are fixed rate loans but an option can be included if the consumer has a variable rate auto loan. Additional fixed rate loans might include a bank credit line, or any other type of lending instruments.

Revolving credit lines are typically credit cards. These are unique because the consumer does not have a set amount to pay each month. Therefore, the term or time period of this type of payment is often unknown. A credit card company assigns a percentage of the principal balance as a minimum payment and this minimum payment will change each month as the principal balance is reduced. The information required for a revolving card is the current balance plus any additional charges since the closing statement, the APR interest rate, and the minimum payment required.

The interest rates for credit cards can vary from month-to-month or depend on the type of charges made. For example, if a consumer has a balance of $5,000, then the system can store data about how much of the balance has been on a cash advance (if any). Typically, a credit card company will charge a different, higher rate for a cash advance transaction versus a regular charge at a department store or other retail merchant. The system also addresses how the credit card company applies payment on these types of balances. Sometimes a certain percentage of payment applies to the cash advance amount and the balance to the normal transaction amount.

The payback period for the credit card can be calculated by gathering the principal amount outstanding, the APR rate on the credit card, the minimum payment due either as an amount or percentage of principal, and a minimum payment can be calculated. From this minimum payment, you can then calculate the number of months to pay off the debt at the current minimum payment.

The system can periodically collect from the user any additional charges on each of their credit cards they have made in the past 30 days. Every month for each debt, the system can analyze what their balance was on the last statement, add any additional charges, add interest charges, subtract payments made, and add the finance charges paid out of each payment.

Some users may have debts that are non-interest bearing, meaning that they do not have interest accruing over time. In these situations, the system gathers the amount of principal, the start date of the note, the payment terms, and the time to pay off the debt. This type of debt needs to be calculated as part of total debt but it would typically be one of the last debts to be paid off because it has no interest.

Milestones are a very important part of a debt reduction, retirement and financial goal guidance system. When a user reaches a milestone or when a debt has been paid in full, a new evaluation of their outstanding debts is made and new a payment strategy may be arranged if necessary.

Lifestyle changes also impact financial and debt reduction management. when evaluating debts for a user over a long-term period, the system allows them to flag any lifestyle changes and allows them to adjust their repayment structure. For example, users can change jobs several times over a 10-year period. When their income adjusts up or down the system recommends adjustments to help them plan debt payments. Some users upgrade their housing every 5+ years. Because this deals with long-term periods, the system allows them to make a “what-if” analysis when they are looking for a new home, a new car, new furniture, etc.

After all of this data has been collected, the system presents the user with an analysis of their situation. This analysis consists of multiple planning options. For example, one option might be to consider simply paying off all existing debts in a strategic fashion using the debt reduction strategies described. The second possible plan is to create a margin, which is defined as reducing ones payment structure on debt, by restructuring debt. This is done in a variety of ways such as refinancing a first mortgage, establishing a second mortgage, or combining credit cards to lower interest debts.

Financial management is also driven by an understanding of a user's cash inflow and outflow. Several obvious cash flows are: monthly pay from an employer, investment income, periodic bonuses, regular commissions, income from the sale of assets (including stocks, bonds, real estate, etc.), miscellaneous sources including hobbies, self-employment income, etc. All of these sources of income and others can be identified to provide complete reporting. This information identifies a user's ability to pay debts off or work toward other financial goals. Cash outflows are tracked in order to create an optimum plan for the user. Of course, some user may spend a significant portion of their money a result of debt payments, but tracking the spending habits of the user is part of future planning too.

For certain debts, the payment frequency can have a dramatic impact on the debt payment. Typically, long-term debts are impacted far more than short-term debts. Short-term debts are defined as 0-5 years, and long-term is any debt that takes longer than 5 years to repay on a normal payment schedule. An evaluation is made based on when users receive their monthly income. When the system analyzes their cash flow, it can capture when a user is paid, whether it is monthly, or bimonthly or weekly. If they receive income weekly or biweekly, then a portion of a monthly payment can be sent prior to the due-date of the debt and the balance of the payment can be sent out at the due date. When these extra payments are applied directly to the principal portion of a debt, it results in significant savings to a user. A biweekly payment on a mortgage loan is done by paying the principal and interest payment towards the debt every two weeks. The result of this event is the borrower will pay one additional payment on his mortgage annually. This system can be implemented efficiently for a user when automation of bill manager is used.

Once the system knows the inflows and outflows of the user's budget the system can determine if there are additional resources to pay down debt. These additional resources are known as power payments. The power payment is part of the overall strategy of paying off debts. The analysis of using a power payment takes the existing debts and applies the power payment to various scenarios, each scenario then produces a report to indicate to the user the impact of applying the power payment to particular debts or investments. From the information provided, the user can decide how to best apply that power payment. Suppose the available money equals two of the principal payments on a debt, every two weeks and the system can suggest making this additional payment. On a $100,000 loan at 8% for 30 years, this will reduce the term of the loan from 30 years to less than 23 years.

An additional option can include the option to pay an extra amount equal to one monthly payment. The effect of this is similar to the logic as described that allows the user to pay one additional principal payment per year that is applied to a mortgage and therefore reduces the payoff term of the loan by a dramatic amount.

Consolidation or debt compression deals with the benefits of consolidating existing debts into one debt or payment. Most people have some equity in their homes or have other means of combining multiple debts into one debt. This can be done through a second mortgage, home equity loan, combining multiple credit cards into one card, refinancing an automobile that is already paid off or paid down, or any other types of consolidating options. The system counsels the user on strategies for combining debts to leverage the combined amount and provide a lower overall payment than having multiple smaller debts each with minimum payments.

In consolidation, the system must determine if the user has the means, through a home equity loan, credit card, or any other way to consolidate their debts. Once it is determined if a source exists to combine debts then the amount of available credit or equity, etc. is compared to the existing debts. For example, if the user has available equity in their home of $25,000 and consumer debts of $18,000, the system projects the new payment and shows them a report that reflects the old payoff schedule compared to the new schedule and the savings in interest and time.

This system calculates the effects of acceleration or power payments. If a user pays additional one-time payments to a debt, the result will be a savings over the term of the debt. The built in wizards for this system analyze the effects of this event and make a recommendation to determine the best use of these additional funds. For example, a user has a debt of $5000 at 18% interest. Then the user receives a bonus of $1000 that they want to use to pay down a debt. The system projects the value of that payment by applying that one-time $1000 payment to debt with the highest ranking and re-evaluates the entire strategy to see the impact of this event. The what-if scenario can apply the $1000 to each debt in the strategy, if desired. A recommendation is then made by the financial system that outlines where this payment will provide the greatest overall benefit, in both time and interest.

Removing payments can also have an adverse effect. If a user decides to alter the payment schedule, they should be notified of the impact of this event. For example, if a user originally has an additional payment of $200 going into the plan and he decides to alter that payment for more than one month then the financial system can present the financial impact if the user drops this payment. If the change results from a reduction in their inflow of cash or an addition to the outflow of cash in their budget, the system will recalculate the user's original debt reduction plan and make the necessary adjustments so they know the impact and overall outcome of their new strategy.

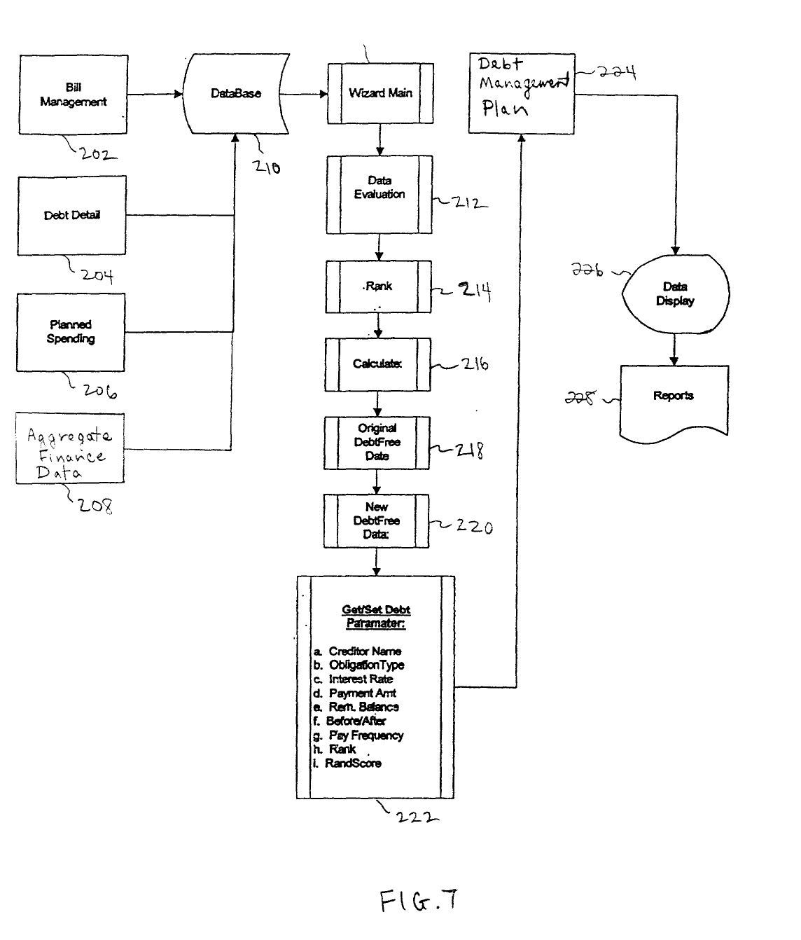

FIG. 7 is a block diagram that illustrates the data flow in the system for preparing a financial management plan. A debt reduction plan or future financial plan 224 takes all the user information following the evaluation and wizard functions and presents it to the user in report format. The plan may include “what-if” calculations and options to help people make financial decisions.

The bill management information 202, the debt detail information 204, planned spending 206, and the aggregate fmance data 208 are collected, processed, and stored in a database 210. Then the main debt management plan wizard is activated 200. The data from all the separate sources is evaluated 212 and a ranking is created for each debt 214, as explained at the beginning of this document. Calculations are performed 216 to produce an original debt free date 218 or the date of debt payoff under the plan the current plan. The contrasting new debt free date 220 is then calculated based on the new plan for the user 224. The detailed information for the plan is then created 222 and the debt management plan is outlined in detail for the user. This data can be displayed for the user 226 or printed out as a paper report 228. This plan can also include planning for retirement or other future spending.

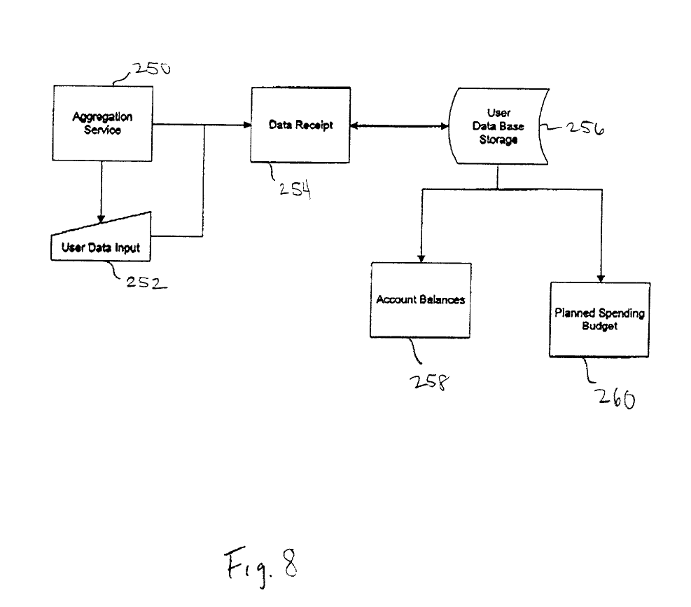

Referring now to FIG. 8, the system draws transactional and account balance data from a data aggregation service 250 which queries online credit card, checking and other financial service providers for very current information. This information includes bill presentment information, deposits, withdrawals, etc. The data flows into the present system and is combined with any user-entered data 252. Then this combined data is presented to the system user 254.

This system then automatically associates the transaction information with specific spending envelopes or budget accounts within the system. The budget amounts for budget categories are increased or decreased based on the transactions applied to them. This gives the user the ability to automatically maintain current budgeting/spending information without laborious manual data entry. Of course, the user is able to override the categorization of data that is received and ultimately control which transactions are sent to which categories. Once the user has sent a specific type of transaction to a user-selected category, the system “remembers” to send the same types of transactions to the same category in the future. This processed data is then stored in a database 256. This provides an advantage over the prior art because the aggregated transaction data is automatically categorized and applied against the budget amounts. The prior art software programs require users to manually enter this information and do not suggest financial plans.

The combination of the data from the aggregation module and the bill manager module provide the ability to have 100% of the users personal financial transactions automatically recorded in the system. A user also has the option to enter transactions manually as needed. The system provides an interface to allow the user view their account balances and transactions 258. Users can view their planned spending budget in relation to the processed aggregated data that has been received 260. Viewing this correlated data allows the user to follow the plan that the system has suggested based on the user's input. A user is then able to reduce debt and plan better because they are always informed of current expenditures and whether or not the budget has been met from day to day.

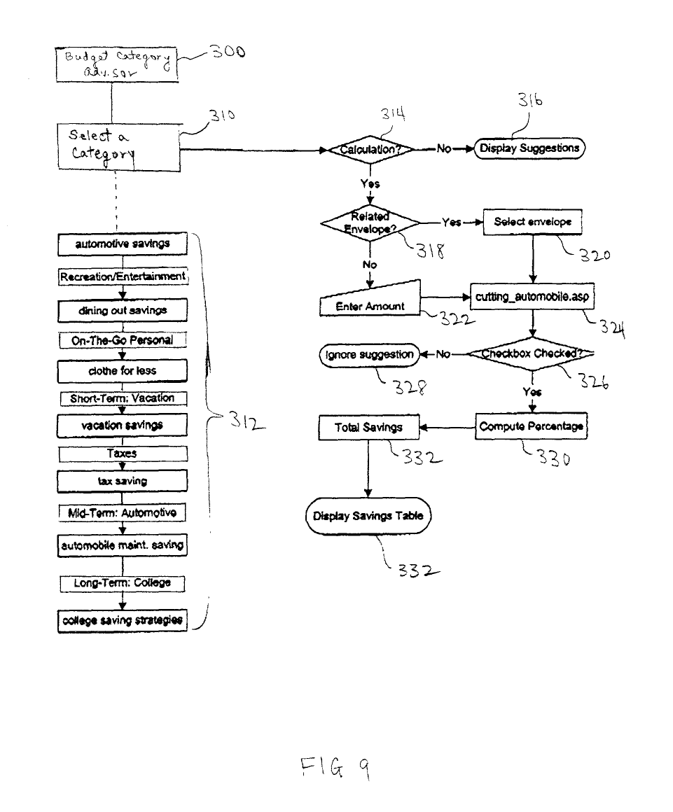

FIG. 9 illustrates cost saving wizards or budget category advisors that provide specific money saving strategies in many different categories. This module provides the ability to determine the amount of money a user can expect to save by implementing a suggested strategy for a category. The calculation is made using the user's specific spending envelope or budget data.

Specifically, in FIG. 9, the user will select a budget category for which they would like to see suggested savings 310. For example, the user can select categories 312 to consider savings for such as automotive, recreation, dining out, “on-the-go”, clothes, vacation, taxes, automobile maintenance, college, savings, etc. Other possible example categories to be considered are utilities, homeownership, insurance, and food.

After a category has been selected, the system must decide if the specific user has data in the category selected with which calculations can be performed 314. If no data is present, then the system displays the general suggestions that are available to save money in the selected category. When data is present, then further calculations are needed. If the user has an envelope or budget that is related to the selected category 318, then that envelope will be selected for use in the calculations 320. Otherwise, the user enters the amount they would like to save over their current spending 322. Then a user interface screen is shown that includes expense reducing items or the possible areas where savings can be taken 324 in a category or envelope. The user can then select whether or not they are interested in those saving areas 326. If the user is not interested in specific saving areas, that suggestion will be excluded from the calculations 328. Then the possible savings based on following the suggested saving areas are computed for the user and the savings percentage 330 and dollar amount is calculated 332 and displayed to the user 334. This calculated savings becomes part of a margin for the user's entire portfolio that can be used for debt reduction. The savings calculated are then applied to a user's debt to create power payments. After a user's debts are paid off, these payments can be applied to retirement or other future planning.

The creation of power payments is significant because previous financial systems have not counseled the user to pay off their debt in an accelerated manner. Further, prior financial systems do not address specific areas where savings may occurs so that a user can create a margin to pay off debt or save for other future finding options.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A method for analyzing a user's finances and providing a plan for debt reduction, the method comprising the steps of:
acquiring aggregated financial data for a user from a financial data clearinghouse;
classifying financial transactions received with the aggregated financial data into a plurality of budget categories without user input;
applying the financial transactions to the budget categories, wherein the budget categories further include a budget amount and budget balance;
modifying the budget balances without user input based on increases or decreases caused by the financial transactions;
displaying the budget categories, budget amounts, modified budget balances and the financial transactions to aid the user in debt reduction.

2. A method as in claim 1 further comprising the step of modifying suggested the budget amounts and budget categories based on the user's input to a pre-filled electronic form displayed to the user.

3. A method as in claim 1, further comprising the step of allowing a user to accept the suggested budget amounts and budget categories.

4. A method as in claim 1, further comprising the step of determining areas of the budget categories where expenses can be reduced.

5. A method as in claim 1, further comprising the step of providing a debt reduction strategy based on the aggregated information received and the suggested budget amounts and budget categories.

6. A method as in claim 1, wherein the step of acquiring aggregated financial data received from the financial clearing house further comprises the step of acquiring aggregated financial data that includes the user's financial account information with deposit and withdrawal information.

7. A method as in claim 1, wherein the step of acquiring aggregated financial data received from the financial clearing house further comprises the step of acquiring bill presentment and payment information.

8. A method for guiding a user to reduce their debt, the method comprising the steps of:
acquiring an aggregation of financial data for a user from a financial data clearinghouse;
classifying financial transactions received with the aggregated financial data into a plurality of budget categories without user input;
applying the financial transactions to the budget categories, wherein the budget categories further include a budget amount;
providing the user with a listing of expense reducing items that can reduce the user's debt;
comparing budget categories and the budget amounts to expense reducing items accepted by the user to define a budget margin for budget categories; and
applying the budget margin to pay down the user's debts.

9. A method as in claim 8, further comprising the step of paying at least a portion of the budget margin toward retirement savings after a portion the user's debt has been paid off.

10. A method as in claim 8, further comprising the step of selecting the debt with the lowest principal balance remaining and the highest interest rate, in order to identify a debt which should be paid off first.

11. A method or determining a financial debt that should be paid down first to reduce aggregate financial debt, comprising the steps of:
storing debt information for a plurality of financial debts, wherein the debt information for each financial debt includes a principal amount, an interest rate, a periodic payment, and a debt payment length;
selecting a debt which has a lowest remaining balance, a highest periodic payment, and a highest interest rate;
communicating to a user that the selected debt should be paid off first to allow the plurality of debts to be paid off in a reduced amount of time.

12. A method in accordance with claim 11, wherein the step of selecting a debt further comprises the step of selecting the debt which has a lowest remaining balance, a highest periodic payment, a highest interest rate, as compared to the remaining balance to pay off the debt.

13. A method for determining a financial debt that should be paid down first to reduce a person's overall financial debt, comprising the steps of:
storing debt information for a plurality of debts, wherein the debt information for each financial debt includes a principal amount, an interest rate, a periodic payment, and a debt payment length;
comparing the periodic payment of each debt to the principal amount;
creating a numerical ranking for each of the debts based on the comparison of the periodic payment to the principal amount; and
identifying the debt to pay off first based on the highest numerical ranking of the debt to allow the plurality of debts to be paid off in a reduced amount of time.

14. A method in accordance with claim 13, further comprising the step of determining a sequence in which for the plurality of debts are paid down to pay the debts off in reduced time.

15. A method in accordance with claim 13, further comprising the step of selecting the debt with the lowest principal balance remaining and the highest interest rate, in order to identify a debt to be paid off first.

16. A method in accordance with claim 15, further comprising the step of applying additional power payments to the debt that has been identified to be paid off first.

17. A method in accordance with claim 13, further comprising the step of selecting the debt with the lowest remaining balance and the highest periodic payment that should be paid off first and to which additional power payments should be applied.

18. A method in accordance with claim 15, further comprising applying a power payment based on the debt with the lowest remaining balance, highest periodic payment and highest interest rate.

19. A method in accordance with claim 13, wherein the step of creating a numerical ranking for each of the debts further comprises the step of creating a numerical ranking for each of the debts based on dividing the periodic payment by an original principal amount or a remaining principal amount.
